(19) United States
(12) Patent Application Publication
(10) Pub. No.: US 2022/0081599 A1
(43) Pub. Date: Mar. 17, 2022

(54) CURABLE ADHESIVE, AND ADHESIVE TAPE, LAMINATE, AND LAMINATED MIRROR BUTTON INCLUDING LA YER INCLUDING THE ADHESIVE

(71) Applicant: 3M INNOVATIVE PROPERTIES COMPANY, St. Paul, MN (US)

(72) Inventors: Shinichi IRIE, Tokyo (JP); Jun FUJITA, Tokyo (JP)

(21) Appl. No.: 17/299,443

(22) PCT Filed: Dec. 20, 2019
(86) PCT No.: PCT/IB2019/061239

§ 371 Date: Jun. 3, 2021

(30) Foreign Application Priority Data
Dec. 26, 2018 (JP) 2018-243135

(51) Int. Cl. C09J 151/00; C09J 7/38; C09J 7/10

(52) U.S. Cl. CPC C09J 151/003; C09J 7/385; C09J 2423/04; C09J 2433/00; C09J 2451/00; C09J 7/10

(57) ABSTRACT

Provided are curable adhesives, along with adhesive tapes, laminates, and laminated mirror buttons that include the curable adhesive. The curable adhesive includes a (meth)acrylate polymer, a curable oxetane compound, a polymer filler, and a photoinitiator for curable oxetane compounds. The curable adhesive, when cured, can provide excellent interfacial failure resistance.

### TECHNICAL FIELD

The present disclosure relates to a curable adhesive, and an adhesive tape, a laminate, and a laminated mirror button including a layer including the adhesive.

### BACKGROUND ART

In recent years, curable adhesives have been widely used in a variety of applications such as dental applications and automotive applications.

Patent Document 1 (JP 2002−516830 A) discloses a photopolymerizable dental composition including (a) a cationically active functional group, (b) a free radically active functional group, and (c) a photo-initiating system that can initiate free radical polymerization of the free radically active functional group after a finite induction period Ti and cationic polymerization of the cationically active functional group after a finite induction period T3 (T3 is greater than T1) at a reaction temperature of lower than about 40° C., the photo-initiating system including (i) a source of a species that can initiate free radical polymerization of a free radically active functional group and cationic polymerization of a cationically active functional group, and (ii) a cationic polymerization modifier, the cationic polymerization of the cationically active functional group being initiated at the end of a finite induction period T2 (T2 is smaller than T3) in the absence of the modifier under the same irradiation conditions. Patent Document 2 (JP 2004−051738 A) discloses a solvent-free photocurable composition including (A) an epoxy resin that is liquid at room temperature, (B) a photocationic polymerization initiator, and (C) a polymer containing at least one type of monomer unit selected from (meth)acrylic esters, diene monomers, and other polymerizable monomer mixtures.

SUMMARY OF INVENTION

Curable adhesives are commonly applied between certain articles, and then cured to bond the articles together. For example, in recent years, when a car room mirror is attached to a windshield, a mirror button for securing the room mirror is used. The mirror button includes an aluminum base substrate and a curable adhesive layer, and is cured by heat or the like for bonding after application of the mirror button to the windshield.

However, known curable adhesives can be peeled at interfaces of these base substrates or glass, so that curable adhesives having excellent interfacial failure resistance, particularly photocurable adhesives have been desired from the perspectives of workability and adhesion between dissimilar materials.

The present disclosure provides a curable adhesive having excellent interfacial failure resistance.

### Solution to Problem

One embodiment of the present disclosure provides a curable adhesive that includes a (meth)acrylate polymer, a curable oxetane compound, a polymer filler, and a photoinitiator for curable oxetane compounds. Another embodiment of the present disclosure provides an adhesive tape that includes a layer including the curable adhesive, and a release liner.

Yet another embodiment of the present disclosure provides a laminate including a substrate and a layer including the curable adhesive.

Yet another embodiment of the present disclosure provides a laminated mirror button that includes a mirror button and a layer including the curable adhesive.

### Advantageous Effects of Invention

The present disclosure provides a curable adhesive having excellent interfacial failure resistance. The above descriptions should not be construed that all embodiments of the present invention and all advantages of the present invention are disclosed.

### BRIEF DESCRIPTION OF DRAWINGS

FIG. 1(a) is a schematic view of the condition before starting a peel strength test, and FIG. 1(b) is a schematic view of the condition after completion of the peel strength test.

### DESCRIPTION OF EMBODIMENTS

The curable adhesive according to the first embodiment of the present disclosure includes a (meth)acrylate polymer, a curable oxetane compound, a polymer filler, and a photoinitiator for curable oxetane compounds. The curable adhesive can reduce or prevent interfacial failure after application to a substrate and/or an adherend and curing.

The curable adhesive according to the first embodiment may include about 30 to about 300 parts by mass of a curable oxetane compound per 100 parts by mass of a (meth)acrylate polymer. When the curable oxetane compound is included in this range, the adhesive layer after curing easily causes cohesive failure rather than interfacial failure while having sufficient adhesive strength, whereby interfacial failure resistance is further improved.

The curable adhesive according to the first embodiment may include about 10 to about 80% by volume of a polymer filler. When the polymer filler is contained in such a range, the adhesive layer after curing easily causes cohesive failure rather than interfacial failure while having a sufficient adhesive strength, and thus further improves interfacial failure resistance.

The (meth)acrylate polymer of the curable adhesive according to the first embodiment may be a polymer obtained from a material including a (meth)acrylate monomer and a carboxylic acid. The curable adhesive including the (meth)acrylate polymer obtained from such a material can further improve the adhesive strength to the substrate and/or adherend after curing.

The content of the carboxylic acid in the (meth)acrylate polymer forming material of the curable adhesive according to the first embodiment may be about 3 to about 20% by mass per 100% by mass of the total amount of the (meth)acrylate monomer and the carboxylic acid. The curable adhesive including the (meth)acrylate polymer obtained from the material can further improve the adhesive strength to the substrate and/or adherend after curing.

As the (meth)acrylate monomers of the (meth)acrylate polymer of the curable adhesive according to the first embodiment, an alkyl (meth)acrylate monomer having a homopolymer glass transition temperature of about 0° C. or lower, and an alkyl (meth)acrylate monomer having a homopolymer glass transition temperature of about 50° C. or higher may be used. The use of these monomers further improves adhesion, interfacial failure resistance, and cohesive failure.

The curable adhesive according to the first embodiment may further include a forming aid polymer. The inclusion of the forming aid polymer improves formability of the curable adhesive into a tape or other forms.

The adhesive tape according to the second embodiment of the present disclosure can be formed using a layer including the curable adhesive of the first embodiment and a release liner. This adhesive tape has excellent interfacial failure resistance.

The laminate according to the third embodiment of the present disclosure can be formed using a layer including the curable adhesive of the first embodiment and a substrate. This laminate has excellent interfacial failure resistance.

The laminated mirror button according to the fourth embodiment of the present disclosure can be formed using a mirror button and a layer including the curable adhesive of the first embodiment. This laminated mirror button has excellent interfacial failure resistance.

Representative embodiments of the present invention are described in detail below for the purpose of illustration by example, but the present invention is not limited to these embodiments.

In the present disclosure, “(meth)acrylate” means acrylate or methacrylate, and “(meth)acrylic” means acrylic or methacrylic.

In the present disclosure, “curing” may also include the concepts commonly referred to as “crosslinking.”

In the present disclosure, “interfacial failure” means peeling at the interface between the cured adhesive layer and the substrate or adherend to which the adhesive layer has been applied. Interfacial failure is not limited to complete peeling of the adhesive layer from the interface of the substrate or adherend, and, for example, may mean that about 70% or more, about 80% or more, or about 90% or more of the area to which the adhesive layer has been applied is detached from the interface of the substrate or adherend.

In the present disclosure, “cohesive failure” means a phenomenon in which a failure occurs in the layer of the adhesive layer. Cohesive failure is not limited to failure in all layers of the adhesive layer, and, for example, may mean that about 70% or more, about 80% or more, or about 90% or more of the areas to which the adhesive layer has applied is broken within the layers of the adhesive layer. In the appearance, the adhesive layer is typically peeled off separately on the substrate side and the adherend side, but the proportion needs not be fifty-fifty, and may be much on one side, and less on the other side (so-called much glue residue remains).

In addition, interfacial failure and cohesive failure may be combined. In a case where about 70% or more, about 80% or more, or about 90% or more of the area to which the adhesive layer has been applied is broken within the layer of the adhesive layer, the failure can be regarded as cohesive failure. Other cases may be regarded as interfacial failure.

In the present disclosure, the term “alkyl” means a linear or branched aliphatic hydrocarbon group. In the present disclosure, the term “branched” means one or more alkyl groups, such as methyl, ethyl or propyl are bonded to a linear alkyl chain. The alkyl group may be unsubstituted or substituted with one or more halo atoms, cycloalkyl groups, or cycloalkenyl groups.

In the present disclosure, the term “cycloalkyl” means a non-aromatic monocyclic or polycyclic ring system, and includes, for example, about 3 to about 12 carbon atoms. Examples of the cycloalkyl ring include cyclopentyl, cyclohexyl, and cycloheptyl. The cycloalkyl group may be substituted with one or more halo atoms, methylene, alkyl, cycloalkyl, heterocyclyl, aralkyl, heteroaralkyl, aryl, or heteroaryl.

In the present disclosure, the term “hetero” means oxygen, nitrogen, or sulfur that substituted one or more carbon atoms.

In the present disclosure, the term “cycloalkenyl” means a non-aromatic monocyclic or polycyclic ring system having a carbon-carbon double bond, and includes, for example, about 3 to about 10 carbon atoms. The cycloalkenyl group may be unsubstituted and substituted with one or more halo atoms, methylene, alkyl, cycloalkyl, heterocyclyl, aralkyl, heteroaralkyl, aryl, or heteroaryl groups.

In the present disclosure, the term “aryl” means an aromatic carbocyclic radical. Examples of the aryl groups include phenyl or naphthyl substituted with one or more aryl group substituents, which may be identical or different. Examples of the “aryl group substituent” include hydrogen, alkyl, cycloalkyl, optionally substituted aryl, optionally substituted heteroaryl, aralkyl, aralkenyl, aralkynyl, heteroaralkyl, heteroaralkenyl, heteroaralkynyl, hydroxy, hydroxyalkyl, alkoxy, aryloxy, aralkoxy, carboxy, acyl, aroyl, halo, nitro, cyano, carboxy, alkoxycarbonyl, aryloxycarbonyl, aralcoxy carbonyl, acylamino, aroylamino, alkylsulfonyl, arylsulfonyl, and other known groups.

The descriptions of the chemical groups listed above are known in the art, and these descriptions are not intended to change the meaning generally recognized. Hereinafter, the components of the curable adhesive (may be referred to simply as “adhesive”) will be further described below.

The adhesive of the present disclosure includes a (meth)acrylate polymer. This (meth)acrylate polymer may be obtained by, for example, further polymerizing a monomer component containing a partial polymer formed by partially polymerizing a monofunctional monomer and optionally a polyfunctional (meth)acrylate (may be referred to as “prepolymer”). Alternatively, if the below-described forming aid polymer is used, a (meth)acrylate polymer can be obtained by polymerizing a monofunctional monomer and optionally a polyfunctional (meth)acrylate without passing through the state of a partial polymer.

Examples of the monofunctional monomer include alkyl (meth)acrylates having 1 to 18 carbon atoms in the alkyl group (which may be referred to as “C1 to 18 alkyl (meth)acrylate”), and unsaturated monomers having a vinylcarbonyl group and a polar group (may be referred to as “polar unsaturated monomer”). The monofunctional monomer may be used alone, or in combination of two or more of them.

The “alkyl (meth)acrylate having 1 to 18 carbon atoms in the alkyl group” means that, for example, the number of carbon atoms in the alkyl alcohol is 1 to 18 when the alkyl (meth)acrylate is considered as an ester of an acrylic acid and an alkyl alcohol. In other words, when the alkyl (meth)acrylate is represented as CH2═CH—COO—R1, R1 is an alkyl group having 1 to 18 carbon atoms.

The number of carbon atoms in the alkyl group of the alkyl (meth)acrylate is preferably 4 or more, and preferably 12 or less. The inclusion of the alkyl (meth)acrylate as a monofunctional monomer improves the adhesion or adhesive strength of the adhesive.

Examples of the alkyl (meth)acrylate include methyl (meth)acrylate, ethyl (meth)acrylate, n-propyl (meth)acrylate, isopropyl (meth)acrylate, n-butyl (meth)acrylate, isobutyl (meth)acrylate, sec-butyl (meth)acrylate, tert-butyl (meth)acrylate, n-pentyl (meth)acrylate, n-hexyl (meth)acrylate, 2-ethylhexyl (meth)acrylate, n-heptyl (meth)acrylate, n-octyl (meth)acrylate, isooctyl (meth)acrylate, n-nonyl (meth)acrylate, isononyl (meth)acrylate, n-decyl (meth)acrylate, n-undecyl (meth)acrylate, n-dodecyl (meth)acrylate, n-tridecyl (meth)acrylate, n-tetradecyl (meth)acrylate, n-pentadecyl (meth)acrylate, n-hexadecyl (meth)acrylate, n-heptadecyl (meth)acrylate, n-octadecyl (meth)acrylate, cyclohexyl (meth)acrylate, 3,3,5-trimethylcyclohexyl (meth)acrylate, isobornyl (meth)acrylate, dicyclopentenyl (meth)acrylate, and dicyclopentanyl (meth)acrylate. Among these, from the perspectives of adhesion, interfacial failure resistance, and cohesive failure, n-butyl (meth)acrylate, isobutyl (meth)acrylate, sec-butyl (meth)acrylate, tert-butyl (meth)acrylate, isobornyl (meth)acrylate, dicyclopentenyl (meth)acrylate, and dicyclopentanyl (meth)acrylate are preferable, and n-butyl (meth)acrylate and isobornyl (meth)acrylate are more preferable.

In particular, from the perspectives of adhesion, interfacial failure resistance, and cohesive failure resistance, it is preferable to use a combination of a low Tg alkyl (meth)acrylate monomer having a homopolymer glass transition temperature (Tg) equal to or lower than the freezing point (about 0° C.), and a high Tg alkyl (meth)acrylate having a homopolymer Tg of about 50° C. or higher.

Examples of the low Tg alkyl (meth)acrylate monomer include n-butyl (meth)acrylate, isobutyl (meth)acrylate, sec-butyl (meth)acrylate, tert-butyl (meth)acrylate, isobornyl (meth)acrylate, methyl (meth)acrylate, ethyl (meth)acrylate, 2-ethylhexyl (meth)acrylate, and isooctyl (meth)acrylate. These can be used alone or in combination.

Examples of the high Tg alkyl (meth)acrylate monomer include isobornyl (meth)acrylate, dicyclopentenyl (meth)acrylate, and dicyclopentanyl (meth)acrylate. These can be used alone or in combination.

The polar unsaturated monomer has a vinylcarbonyl group and a polar group. Examples of the polar group include a hydroxyl group, a carboxyl group, a carbamoyl group, an amino group, an epoxy group, and a nitrile group. Among them, a hydroxyl group, a carboxyl group, and an amino group are preferable.

The vinylcarbonyl group refers to a group represented by CH2═CH—C(═O)—. The Si—H group and the polar group may be directly bonded or may be bonded via a linking group such as an alkylene group.

Examples of the polar unsaturated monomers include:

hydroxyl group-containing unsaturated monomers such as 2-hydroxyethyl (meth)acrylate, 3-hydroxypropyl (meth)acrylate, 4-hydroxybutyl (meth)acrylate, polyethylene glycol (meth)acrylate, and polypropylene glycol (meth)acrylate; carboxyl group-containing unsaturated monomers such as acrylic acid, itaconic acid, maleic acid, and fumaric acid (may be referred to simply as “carboxylic acid”);

carbamoyl group-containing unsaturated monomers such as acrylamide; amino group-containing monomers such as N,N-dimethylaminoethyl (meth)acrylate, N,N-diethylaminoethyl (meth)acrylate, and N,N-dimethyl aminopropyl (meth)acrylate; and epoxy group-containing unsaturated monomers such as glycidyl (meth)acrylate.

From the perspective of adhesion, particularly adhesion in low-temperature environments, carboxylic acids are preferable, and specifically acrylic acid is more preferable.

Examples of the polyfunctional (meth)acrylate as an optional component include 1,6-hexanediol di (meth)acrylate, 1,9-nonanediol di (meth)acrylate, ethylene glycol di(meth)acrylate, polyethylene glycol di(meth)acrylate, propylene glycol di(meth)acrylate, polypropylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, and tetramethylol methane tri(meth)acrylate.

In a case where a polyfunctional (meth)acrylate is used, the content of the polyfunctional (meth)acrylate in the monomer component may be, for example, about 0.05 mmol or more or about 0.1 mmol or more, and may be about 2.0 mmol or less relative to 100 g of the monofunctional monomer.

The partial polymer (prepolymer) is formed by partially polymerizing a monomer component, and may also be referred to as a “partial polymer of a monomer component (prepolymer)”.

Here, “partial polymer” refers to a composition in which at least a portion of the monomer component is polymerized, and an unreacted ethylenically unsaturated bond (C═C) derived from a monofunctional monomer or a polyfunctional (meth)acrylate is present in the composition.

The viscosity of the partial polymer at 25° C. may be, for example, about 500 mPa·s or more, and may be about 10000 mPa·s or less, about 8000 mPa·s or less, or about 5000 mPa·s or less. When the viscosity range of the partial polymer is within this range, for example, when forming the adhesive tape, it can be applied with a certain thickness without dripping into a release liner or the like. The viscosity defined here is a value measured using a Type B viscometer (BH type) manufactured by Tokyo Keiki Co., Ltd. (Minato-ku, Tokyo, Japan). The measurement is performed at 25° C. using a #5 or #6 rotor (rotation speed: 20 rpm), and the value measured 1 minute after the start of the measurement is taken as the measurement value.

The viscosity of the partial polymer varies depending on the degree of progression of the partial polymerization, and the viscosity of the partial polymer tends to increase as partial polymerization progresses. Therefore, the viscosity of the partial polymer can be easily adjusted to the desired range by appropriately adjusting the amount of the polymerization initiator used in the partial polymerization and the reaction time of the partial polymerization, and the like.

The partial polymer may also be said to include an unreacted monomer component and a solid component that is a polymer of the monomer component. Here, the solid content in the partial polymer may be, for example, about 1% by mass or more or about 2% by mass or more, and about 10% by mass or less or about 7% by mass or less, based on the total amount of the partial polymer.

The solid content in the partial polymer can be determined by measuring the amount of remaining solids after removal of the unreacted monomer component from the partial polymer. For example, the mass after drying the partial polymer in an oven at about 120° C. for about two hours may be used as a solid content.

The partial polymer can be obtained by, for example, adding a photoinitiator to a monomer component, followed by light irradiation, and then photopolymerizing the monomer component.

Examples of the photopolymerization initiator include azo-based compounds such as azobisinbutyronitrile;

benzoins such as benzoin, benzoin methyl ether, benzoin ethyl ether, benzoin isopropyl ether, benzoin isobutyl ether, α-methylbenzoin, and α-phenylbenzoin;

anthraquinones such as anthraquinone, methylanthraquinone, and chloranthraquinone; and onium salts such as p-methoxybenzenediazonium, hexafluorophosphate, diphenyliodonium, and triphenylsulfonium.

Examples of the photopolymerization initiator include benzyl dialkyl ketals such as 2,2-dimethoxy-1,2-diphenylethane-1-one (benzyldimethylketal);

α-hydroxyalkylphenones such as 1-hydroxy-cyclohexyl-phenyl-ketone, 2-hydroxy-2-methyl-1-phenyl-propan-1-one, 1-[4-(2-hydroxyethoxy)-phenyl]−2-hydroxy-2-methyl-1-propan-1-one, and 2-hydroxy-1-{4-[4-(2-hydroxy-2-methyl-propionyl)-b enzyl]phenyl}−2-methyl-propan-1-one;

α-aminoalkylphenones such as 2-methyl-1-(4-methylthiophenyl)-2-morpholinopropan-1-one and 2-benzyl-2-dimethylamino-1-(4-morpholinophenyl)-butanone-1,2-(dimethylamino)-2-[(4-methylphenyl)methyl]−1-[4-(4-morpholinyl)phenyl]−1 -butanone;

acylphosphine oxides such as 2,4,6-trimethylbenzoyl-diphenyl-phosphine oxide and bis(2,4,6-trimethylbenzoyl)-phenylphosphine oxide;

titanocenes such as bis(η5−2,4-cyclopentadiene-1-yl)-bis(2,6-difluoro-3-(1H-pyrrol-1-yl)-phenyl)titanium; and
oxime esters such as 1,2-octanedione, 1-[4-(phenylthio)-,2-(O-benzoyloxime)], ethanone, and 1-[9-ethyl-6-(2-methylbenzoyl)-9H-carbazol-3-yl]-,1-(O-acetyloxime).

The content of the photopolymerization initiator used in the preparation of the partial polymer may be about 0.01 parts by mass or more or about 0.05 parts by mass or more, and about 1.0 parts by mass or less or about 0.5 parts by mass or less per 100 parts by mass of the partial polymer.

The light irradiation may use, for example, irradiation with UV, electron beams, or X-rays. For example, a partial polymer can be obtained by subjecting a monomer component containing a photoinitiator to UV irradiation with an irradiation intensity of about 0.05 mW/cm2 or more or about 0.1 mW/cm2 or more, about 10 mW/cm2 or less or about 5 mW/cm2 or less, for an irradiation time of about 5 seconds or more or about 10 seconds or more, and about 300 seconds or less or about 240 seconds or less.

The forming aid polymer may be used in the formation of the (meth)acrylate polymer. The use of a forming aid polymer can increase viscosity without passing through the state of the partial polymer. As a result, even if an unreacted monomer component is used, for example, when forming the adhesive tape, it can be applied with a certain thickness without dripping into a release liner or the like.

The forming aid polymer is not particularly limited as long as it is compatible with the above-described monomer component and thickens the system including the monomer component. Examples thereof include polyvinyl butyral (PVB), polymethyl methacrylate (PMMA), and phenoxy resins. The forming aid polymer may be used alone or in combination of two or more thereof.

The content of the forming aid polymer may be appropriately adjusted so as to obtain the desired viscosity and is not particularly limited, and may be defined as, for example, about 5 parts by mass or more, about 7 parts by mass or more, or about 10 parts by mass or more, and may be defined as about 30 parts by mass or less, about 25 parts by mass or less, or about 20 parts by mass or less per 100 parts by mass of the (meth)acrylate polymer.

The (meth)acrylate polymer can be obtained by further polymerizing the partial polymer described above. Alternatively, in a case where a forming aid polymer is used, it can be obtained by polymerizing a monofunctional monomer and optionally a polyfunctional (meth)acrylate without passing through the state of a partial polymer.

The photopolymerization initiator in the polymerization of the (meth)acrylate polymer may be the photopolymerization initiator described above. In a case where a partial polymer is used, it may be an unreacted product of the photopolymerization initiator used in the production of the partial polymer, and may be newly added after the production of the partial polymer, but the latter is more preferable in consideration of productivity and the like.

The photopolymerization initiator used in the polymerization of the (meth)acrylate polymer is preferably different from the photoinitiator for the curable oxetane compounds described below. In particular, the photopolymerization initiator preferably has a light absorption wavelength that is greater than or equal to the light absorption wavelength (excitation wavelength) of the photoinitiator for curable oxetane compounds by about 20 nm or more, about 30 nm or more, or about 40 nm or more. The use of the photopolymerization initiator allows polymerization of the (meth)acrylate polymer and the polymerization of the curable oxetane compound in two stages.

The content of the photopolymerization initiator used in the preparation of the (meth)acrylate polymer may be about 0.01 parts by mass or more or about 0.05 parts by mass or more, and may be about 1.0 parts by mass or less or about 0.5 parts by mass or less per 100 parts by mass of the (meth)acrylate polymer.

In a case where a carboxylic acid (carboxyl group-containing unsaturated monomer) is used in the preparation of the (meth)acrylate polymer, the content of the carboxylic acid is preferably about 3.0% by mass or more, about 4.0% by mass or more, or about 5.0% by mass or more, and preferably about 20.0% by mass or less, about 15.0% by mass or less, or about 10.0% by mass or less per 100% by mass of the total amount of the (meth)acrylate monomer and the carboxylic acid. When carboxylic acid is included in such a range, adhesion of the curable adhesive, and in particular, adhesion in low-temperature environments can be improved.

Here, the “ (meth)acrylate monomer” may mean a monomer component of the (meth)acrylate polymer system other than carboxylic acid among the monomer components of the (meth)acrylate polymer. A “low-temperature environment” may mean, for example, a winter environment, and specifically, for example, an environment at about 0° C. or lower, about −5° C. or lower, or about −10° C. or lower. The lower limit of the temperature in the low-temperature environment is not particularly limited, but may be defined as, for example, about −50° C. or higher, about −45° C. or higher, or about −40° C. or higher.

The curable oxetane compound used in the adhesive of the present disclosure may be any oxetane compound that can be cured by irradiation with light (for example, UV, electron beams, or X-rays).

Examples thereof include, but not limited to, known compounds having one or more oxetane rings in the molecule, such as 3,3-bis(vinyloxymethyl)oxetane, 3-ethyl-3-(hydroxymethyl)oxetane, 3-ethyl-3-(2-ethyl hexyl oxymethyl)oxetane, 3-ethyl-3-[(phenoxy) methyl]oxetane, 3-ethyl-3-(hexyloxymethyl)oxetane, 3-ethyl-3-(chloromethyl)oxetane, 3,3-bis(chloromethyl)oxetane, 1,4-bis[(3-ethyl-3-oxetanylmethoxy)methyl]benzene, bis {[1-ethyl (3-oxetanyl)] methyl} ether, 4,4′-bis[(3-ethyl-3-oxetanyl) methoxymethyl] bicyclohexyl, 1,4-bis [(3-ethyl-3-oxetanyl)methoxymethyl]cyclohexane, 1,4-bis {[(3-ethyl-3-oxetanyl)methoxy]methyl }benzene, 3-ethyl-3-{[(3-ethyl oxetane-3-yl)methoxy]methyl) }oxetane, xylylenebisoxetane, 3-ethyl-3-{[3-(triethoxysilyl)propoxy]methyl}oxetane, oxetanylsilsesquioxane, and phenol novolak oxetane. Among these, from the perspectives of interfacial failure and cohesive failure, 3-ethyl-3-{[((3-ethyl oxetane-3-yl)methoxy]methyl)}oxetane and xylylenebisoxetane are preferable. These oxetane compounds may be used alone or in combination of two or more thereof.

The content of the curable oxetane compound may be adjusted as appropriate in accordance with the required interfacial failure resistance, cohesive failure, and the like, and may be, for example, but not limited to, about 30 parts by mass or more, about 35 parts by mass or more, or about 40 parts by mass or more, and may be about 300 parts by mass or less, about 250 parts by mass or less, or about 200 parts by mass or less per 100 parts by mass of the (meth)acrylate polymer.

The photoinitiator for curable oxetane compounds used in the adhesive of the present disclosure is not particularly limited as long as it generates a cation or a Lewis acid by irradiation with light (for example, UV, electron beams, or X-rays) and initiates polymerization of an oxetane compound.

Examples thereof include sulfonium salt photoinitiators, iodonium salt photoinitiators, and diazonium salt photoinitiators. These may be used alone or in combination of two or more of them.

Examples of the sulfonium salt photoinitiator include triarylsulfonium salts such as tri phenyl sulfonium hexafluorophosphate, tri phenyl sulfonium hexafluoroantimonate, triphenylsulfonium tetrakis(pentafluorophenyl) borate, diphenyl-4-(phenylthio) phenylsulfonium hexafluorophosphate, diphenyl-4-(phenylthio) phenyl sulfonium hexafluoro Antimonate, 4,4′-bis [diphenyl sulfonio]diphenyl sulfide bishexafluorophosphate, 4,4′-bis[di(β-hydroxyethoxy) phenylsulfonio]diphenyl sulfide bishexafluoroantimonate, 4,4′-bis[di(β-hydroxyethoxy)phenylsulfonio]diphenyl sulfide bishexafluorophosphate, 7-[di (p-toluyl)sulfonio]−2-isopropylthioxanthone hexafluoroantimonate, 7-[di(p-toluyl)sulfonio]−2-isopropylthioxanthone tetrakis(pentafluorophenyl)borate, 4-phenylcarbonyl-4′-diphenylsulfonio-diphenylsulfide hexafluorophosphate, 4-(p-tert-butylphenylcarbonyl)-4′-diphenylsulfonio-diphenylsulfide hexafluoroantimonate, and 4-(p-tert-butylphenylcarbonyl)-4′-di(p-toluyl)sulfonio-diphenylsulfide tetrakis(pentafluorophenyl)borate.

Examples of the iodonium salt photoinitiator include diaryliodonium salts such as diphenyliodonium tetrakis(pentafluorophenyl)borate diphenyliodonium hexafluorophosphate, diphenyliodonium hexafluoroantimonate, di(4-tert-butylphenyl) iodonium hexafluorophosphate, di (4-tert-butylphenyl)iodonium hexafluoroantimonate, triylcumyliodonium tetrakis(pentafluorophenyl)borate, (4-methylphenyl)[4-(2-methylpropyl)phenyl]-hexafluorophosphate, di(4-nonylphenyl)iodonium hexafluorophosphate, and di(4-alkylphenyl)iodonium hexafluorophosphate.

Examples of the diazonium salt photoinitiator include benzenediazonium hexafluoroantimonate and benzenediazonium hexafluorophosphate.

Among these photoinitiators, from the perspective of compatibility, curability, and the like, sulfonium salt photoinitiators are preferable, and triphenylsulfonium hexafluoroantimonate is more preferable.

The content of the photoinitiator for curable oxetane compounds may be adjusted as appropriate in accordance with the required curability and the like, and may be, for example, but not limited to, about 1.0 parts by mass or more, about 1.5 parts by mass or more, or about 2.0 parts by mass or more, and may be about 15 parts by mass or less, about 10 parts by mass or less, or about 5.0 parts by mass or less per 100 parts by mass of the curable oxetane compound.

The content of the photoinitiator generally contributes to the curing speed of the curable oxetane compound. Therefore, when the curing is desired to be delayed, for example, in a case where an adhesive tape after irradiation with light is desired to be cured for bonding after a while from attaching the tape to an adherend, the content of the photoinitiator is preferably in the range of from about 1.0 to about 10 parts by mass. When a photoinitiator is included within this range, the time from the light irradiation to completion of the curing can be appropriately delayed in a range from about 5 minutes to 1 day.

In a case where the curing is desired to be accelerated, for example, when an adhesive tape is applied to a transparent adherend such as glass, and then irradiated with light from the adherend side for immediate curing and bonding, the content of the photoinitiator is preferably in the range of about 1.5 to 15 parts by mass.

The curing rate of the curable oxetane compound can be controlled by appropriately adjusting the irradiance of light.

The polymer filler used in the adhesive of the present disclosure may be any adhesive as long as it can impart cohesive failure properties to the adhesive after curing, and may be solid or hollow. The polymer filler may be used alone or in combination of two or more thereof.

Examples thereof include, but not limited to, a matrix resin of the adhesive after curing, in particular a polymer filler that is hard to bond to a (meth)acrylate polymer, such as aliphatic polymer fillers such as a polyethylene filler, and acrylonitrile polymer fillers including acrylonitrile as a constituent.

The content of the polymer filler may be adjusted as appropriate in consideration of adhesive strength, cohesive failure, and the like, and may be, for example, but not limited to, about 0.3 parts by mass or more, about 0.4 parts by mass or more, or about 0.5 parts by mass or more, and about 45 parts by mass or less, about 40 parts by mass or less, or about 35 parts by mass or less per 100 parts by mass of the (meth)acrylate polymer.

Alternatively, the content of the polymer filler in the adhesive may be about 10% by volume or more, about 15% by volume or more, or about 20% by volume or more, and may be about 80% by volume or less, about 70% by volume or less, or about 60% by volume or less.

The size (average particle size) of the polymer filler may be selected as appropriate in consideration of the adhesive strength, cohesive failure, and the like, and may be defined as, but not limited to, about 5 micrometers or more, about 7 micrometers or more, or about 9 micrometers or more. The upper limit value is not particularly limited, but from the perspective of drop-off resistance, it may be defined as about 200 micrometers or less, about 180 micrometers or less, or about 160 micrometers or less. The polymer filler of this size tends to cause cohesive failure of the adhesive after curing. The size (average particle size) of the polymer filler can be determined by, for example, a laser diffraction/scattering method.

The curable adhesive of the present disclosure may include, as optional components, for example, release agents, fillers other than polymer fillers, conductive agents, thermally conductive agents, antioxidants, ultraviolet absorbers, photostabilizers, thermal stabilizers, dispersants, plasticizers, lubricants, surfactants, leveling agents, silane coupling agents, catalysts, pigments, and dyes within a range that does not affect the effects of the present invention. In a case where a silane coupling agent is included, performance such as moist heat resistance will improved.

Inorganic fillers such as silica and PMMA fillers that easily adhere to the matrix resin component of the adhesive tend to form a crosslinking point with the matrix resin component, and thus tend to decrease cohesive failure properties of the adhesive after curing to easily cause interfacial failure. Accordingly, such fillers may be added at a ratio of about 10% by volume or less, about 8% by volume or less, or about 5% by volume or less, but are more preferably not added.

Because the curable adhesive of the present disclosure includes certain components, particularly a curable oxetane compound and a polymer filler, the cured product of the adhesive (which may be referred to simply as “cured product”) can provide sufficient adhesive strength, and additionally can provide properties to cause cohesive failure rather than interfacial failure.

“Interfacial failure” means peeling at the interface between the cured adhesive layer and the substrate or adherend to which the adhesive layer has been applied.

Therefore, adhesives prone to interfacial failure are readily influenced by the state of the bonded surface of the substrate or adherend (for example, contamination), so appropriate control of the surface of the substrate or adherend to be bonded is necessary, and this can cause the decrease in productivity. In addition, adhesives which tend to interfacial failure are easily peeled off by stress concentration, so that the adhesive strength at the interface depends on the location and manner of the stress application. On the other hand, the adhesive of the present disclosure causes cohesive failure rather than interfacial failure, so that its adhesive strength at the interface less likely depends on the location and manner of stress application than adhesives prone to interfacial failure, while sufficient adhesive strength at the interface is kept.

The cured product of the adhesive of the present disclosure can provide a sufficient adhesive strength. The adhesive strength can be evaluated, for example, in the peel strength test described in the examples described below. For the failure mode of the adhesive in the peel strength test, “cohesive failure” can be achieved. The peel strength may be defined as, for example, about 0.20 kN or more, about 0.22 kN or more, or about 0.24 kN or more at −30° C.; about 0.30 kN or more, about 0.32 kN or more, or about 0.34 kN or more at 25° C.; and about 0.18 kN or more, about 0.20 kN or more, or about 0.22 kN or more at 80° C. per about 4.8 cm2 of the bonding area. The upper limit value of the peel strength is not particularly limited, and may be defined as, for example, about 10 kN or less, about 8 kN or less, or about 6 kN or less at −30° C.; about 20 kN or less, about 16 kN or less, or about 12 kN or less at 25° C.; and about 10 kN or less, about 8 kN or less, or about 6 kN or less at 80° C. per about 4.8 cm2 of the bonding area.

Here, even if the peel strength is the same value, the adhesive causing failure in the “cohesive failure” mode is superior in the adhesive strength at the interface to that causes failure in the “interfacial failure” mode.

The curable adhesives of the present disclosure can be used in a variety of applications. In particular, the photocurable adhesive has advantages such as excellent workability because it does not require heating in the bonding process, and also suppression of strains during shrinkage due to the difference in the coefficient of thermal expansions, even in the case of bonding of dissimilar materials. Examples of the usage of the curable adhesive of the present disclosure include, but not limited to, an adhesive tape including a curable adhesive layer and a release liner; a laminate including a curable adhesive layer, a substrate, and optionally a release liner; and a kit including a curable adhesive or the adhesive tape described above, and a UV irradiation light. More specifically, it can be used in various vehicle fields such as vehicles, ships, and aircrafts, the fields of various manufacturing apparatuses, robot fields, architectural fields, and medical fields. The curable adhesives of the present disclosure can exhibit sufficient performance in low temperature regions at about −30° C., and thus can also be used in applications such as those used in low-temperature environments.

The release liner may be applied to at least one side of the curable adhesive layer. Examples of the release liner include paper; plastic materials such as polyethylene, polypropylene, polyester and cellulose acetate; and papers coated with such plastic materials. These release liners may have surfaces release-treated with silicone or the like. The thickness of the release liner may be, for example, about 5 micrometers or more, about 15 micrometers or more, or about 25 micrometers or more, and may be about 500 micrometers or less, about 300 micrometers or less, or about 200 micrometers or less.

The substrate is a member that is not intended to be peeled away different from the release liner, and is a member that is bonded to the adherend described below via an adhesive layer. The material of the substrate is not particularly limited, and examples thereof include, but not limited to, metals or metal alloys such as aluminum used in mirror buttons; resin materials such as PET; rubber materials; inorganic materials such as glass, ceramics, and concrete; and wood materials.

The shape of the substrate is not particularly limited, and may be, for example, a flat shape such as a film or a plate; a curved shape; or various three-dimensional shapes.

The adherend to which the laminate including the curable adhesive layer and the substrate is applied is not particularly limited. Examples of the material of the adherend include, but not limited to, metals or metal alloys such as aluminum; resin materials such as PET; rubber materials; inorganic materials such as glass, ceramics, and concrete; and wood materials.

The shape of the adherend is also not particularly limited, and may be, for example, a flat shape such as a film or a plate; a curved shape; or various three-dimensional shapes.

The thickness of the curable adhesive layer may be selected appropriately in consideration of the required adhesive strength, cohesive failure, and the like, and may be, for example, but not limited to, about 40 micrometers or more, about 70 micrometers or more, or about 100 micrometers or more, and may be about 4 mm or less, about 3 mm or less, or about 2 mm or less.

The method for producing the curable adhesive of the present disclosure is not particularly limited. As an example, a method for producing an adhesive tape using the curable adhesive of the present disclosure is described below.

For example, a material in which a (meth)acrylate monomer and a photoinitiator for the monomer are mixed is irradiated with light to prepare a partially prepolymerized solution, or a (meth)acrylate monomer, a photoinitiator for the monomer, and the forming aid polymer described above are mixed to prepare a mixture. Either of them, a curable oxetane compound, a photoinitiator for curable oxetane compounds, a polymer filler, and optionally a carboxylic acid are mixed to prepare a slurry.

The resulting slurry is applied onto a release liner using a known method such as coating, and as necessary, a release liner is further applied onto the slurry layer. Next, the slurry layer is irradiated with light having a specific wavelength (UV or the like) that reacts only with the photoinitiator for the (meth)acrylate monomer, thereby polymerizing the (meth)acrylate monomer and optional carboxylic acid to obtain an adhesive tape including the curable adhesive of the present disclosure.

The usage of the adhesive tape of the present disclosure is not particularly limited. As an example, the usage of a delayed curing adhesive tape is described below.

For example, in a case where a release liner is applied to both sides of the adhesive tape, one release liner is removed, and the exposed curable adhesive layer is applied to the substrate (for example, a mirror button) described above to prepare a laminate (for example, a laminated mirror button). Here, if the release liner is difficult to remove, the adhesive tape may be cooled.

Next, light (e.g., UV) that reacts with the photoinitiator for curable oxetane compounds is applied to the top of the release liner of the laminate, or to the curable adhesive layer exposed by removing the release liner, thereby initiating polymerization reaction of the curable oxetane compound. Next, the curable adhesive layer is bonded to the adherend (e.g., glass) described above before completion of the polymerization reaction.

The curable adhesive of the present disclosure can be cured after some delay, it can provide a sufficient adhesive strength to the substrate and adherend after light irradiation even if the substrate and adherend are opaque materials.

### EXAMPLES 1-18 (EX1-EX18) AND COMPARATIVE EXAMPLES 1-4 (CE1-CE4)

Specific embodiments of the present disclosure are exemplified in the following examples, but the present invention is not limited to these embodiments.

The products, materials, and the like used in Examples are illustrated in Table 1 below.

TABLE 1

| Designation | Description | Provider |
|---|---|---|
| IBXA | Isobornyl acrylate | Osaka Organic Chemical Industry |
| | | Ltd. (Chuo-ku, Osaka, Japan) |
| BA | Butyl acrylate | Mitsubishi Chemical Corporation |
| | | (Chiyoda-ku, Tokyo, Japan) |
| AA | Acrylic acid | Toagosei Co., Ltd. (Minato-ku, |
| | | Tokyo, Japan) |
| MAA | Methacrylic acid | Mitsubishi Chemical Corporation |
| | | (Chiyoda-ku, Tokyo, Japan) |
| 1.6HXA | 1,6-hexanediol diacrylate | Kyoeisha Chemical Co., Ltd. (Chuo- |
| | | ku, Osaka, Japan) |
| KBM403 | Glycidyl[3- | Shin-Etsu Chemical Co., Ltd |
| | (trimethoxysilyl)propyl]ether | (Chiyoda-ku, Tokyo, Japan) |
| OXT121 | Xylylenebisoxetane | Toagosei Co., Ltd. (Minato-ku, |
| | | Tokyo, Japan) |
| S221 | 3-ethyl-3-[(3-ethyloxetane-3- | Synasia (U.S.) |
| | yl)methoxymethyl]oxetane | |
| YD128R | Bisphenol A diglycidyl ether | Shinnikka Epoxy Manufacturing Co. |
| | | (Chiyoda-ku, Tokyo, Japan) |
| HBE100 | Hydrogenated bisphenol A | New Japan Chemical Co., Ltd. |
| | diglycidyl ether | (Chuo-ku, Osaka, Japan) |
| DME100 | 1,4-Cyclohexanedimethanol | New Japan Chemical Co., Ltd. |
| | diglycidyl ether | (Chuo-ku, Osaka, Japan) |
| SP3 | Silica filler | Marukama Ltd. (Mizunami-shi, |
| | | Gifu-shi, Japan) |
| 1055C | Polyethylene filler (average particle | Tokyo Printing Ink Mfg. Co., Ltd. |
| | size: about 100 micrometers) | (Kita-ku, Tokyo, Japan) |
| TS720 | Silane-treated fumed silica | Cabot (U.S.) |
| LE2080 | Polyethylene filler (average particle | Sumitomo Seika Chemicals Co., |
| | size: about 10 micrometers) | Ltd. (Chuo-ku, Osaka, Japan) |
| F80DE | Acrylonitrile copolymerized plastic | Matsumoto Yushi-Seiyaku Co., Ltd. |
| | microballoon (average particle size: | (Yao-shi, Osaka, Japan) |
| | about 90 to about 130 micrometers) | |
| Runtecure | Benzyl dimethyl ketal | Wealth Ocean (U.S.) |
| (trademark) | | |
| 1065 | | |
| Irg819 | Bis(2,4,6-trimethylbenzoyl)- | BASF Japan Ltd. (Minato-ku, |
| | phenylphosphineoxide | Tokyo, Japan) |
| CP101A | Triaryl-surfonium | San-Apro Ltd. (Higashiyama-ku, |
| | hexafluoroantimonate in propylene | Kyoto, Japan) |
| | carbonate | |
| B76 | Polyvinyl butyral | Eastman Chemical Japan Ltd. |
| | | (Minato-ku, Tokyo, Japan) |

Specific materials represented in Table 1 were appropriately mixed according to the recipes shown in Table 2, the mixture was irradiated with UV and thickened to prepare (meth)acrylate partial polymers (M1 and M2). The numerical values in Table 2 are all in units of parts by mass.

TABLE 2

| | M1 | M2 |
|---|---|---|
| IBXA | 43.07 | 38.33 |
| BA | 56.92 | 61.66 |
| Runtecure (trademark) | 0.01 | 0.01 |
| 1065 | | |
| Total | 100.00 | 100.00 |

The materials shown in Table 1 and the (meth)acrylate partial polymers (M1 and M2) shown in Table 2 were appropriately mixed at the mixing ratios shown in Tables 3 to 6, thus preparing slurries. Using a hand coater having a gap spacing of about 0.5 to about 0.6 mm, each slurry was coated onto the first release PET liner, which had been subjected to a release treatment with silicone, and the second release PET liner was further applied to the coating layer, thereby preparing a laminate A. Next, the laminate A was irradiated with UV at an irradiation intensity of 3 mW/cm² for 10 minutes using a LED light with a peak emission wavelength of 405 nm, and only the (meth)acrylate polymer was polymerized to prepare an adhesive tape. Here, the numerical values for the filler components in Tables 3 to 6 mean parts by mass and the volume fraction (% by volume), and all the numerical values for other components mean parts by mass. For the (meth)acrylate component in the table, the total amount of constituents of the (meth)acrylate polymer is 100 parts by mass. Additionally, for example, M1 and 1.6HXA in Example 1, IBXA, BA, MAA, and 1.6HXA in Example 9 are constituents of the (meth)acrylate polymer, and B76 in Example 9 is not a monomer constituting the (meth)acrylate polymer. For Example 18 (EX18), the slurry was directly applied to the mirror button using an applicator so that the thickness was about 0.6 to 0.7 mm.

### Evaluation Test

The adhesive strength and failure mode of the adhesive tape including the curable adhesive layer was evaluated using the following method. The results are shown in Tables 3 to 6.

### Method for Preparing Test Piece

An aluminum mirror button having a bonding surface of about 25 mm×about 30 mm and tempered glass of about 100 mm×about 100 mm×about 5 mm were prepared, and the bonding surfaces of the mirror button and the tempered glass were cleaned with isopropyl alcohol. The adhesive tape was cut to a size of about 25 mm×about 30 mm, and the first release PET liner was removed under cooling as necessary, and the curable adhesive layer of the adhesive tape was applied to the adhesive surface of the mirror button under pressure. The second release PET liner was removed under cooling as necessary, and the exposed curable adhesive layer was irradiated with UV-A radiation for about 5.5 seconds with a LED light (UVX365, manufactured by Microsquare, Inc.) having a peak emission wavelength of 365 nm. Here, the UV-A irradiance was about 7.5 J/cm² as measured with a Power Puck II radiometer (manufactured by EIT). After the exposed curable adhesive layer was applied to the tempered glass under pressure, curing was completed by standing at room temperature for 24 hours or longer, thereby preparing a test piece.

### Adhesive Strength: Peel Strength

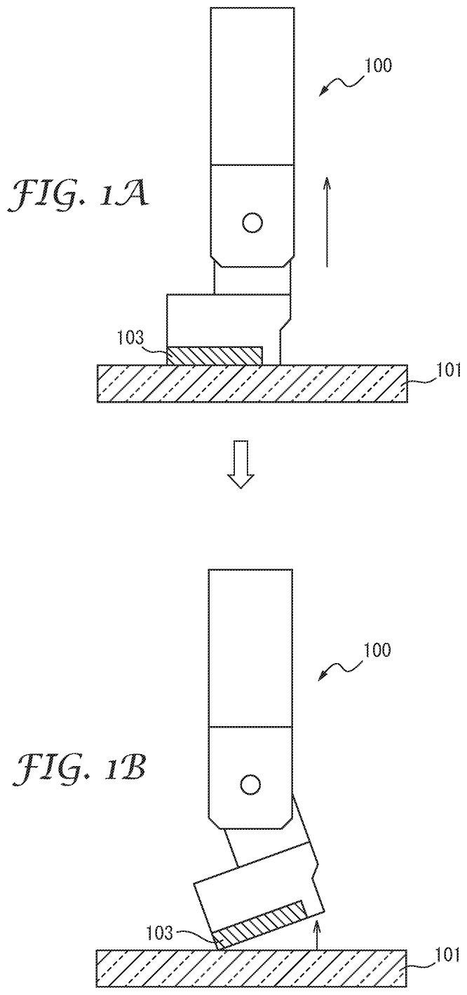

Using a jig 100 shown in FIG. 1, a force for peeling the mirror button from one of the tips of the mirror button 103 in its long axis direction (the upward arrow in FIG. 1(a)) was applied to the mirror button 103 at a rate of 50 mm/minute, and the peel strength was measured. The results are shown in Tables 3 to 6. In the test, measurements were performed in atmospheres at about −30° C., about 25° C., and about 80° C. Here, “CF” in the table means that the adhesive layer caused cohesive failure, “AF (AL)” means that the adhesive layer caused interfacial failure from the aluminum mirror button, and “AF (GL)” means that the adhesive layer caused interfacial failure from the tempered glass 101.

TABLE 3

| | | | EX1 | EX2 | EX3 | EX4 | EX5 | EX6 | CE1 | CE2 | CE3 | CE4 | CE5 |
|---|---|---|---|---|---|---|---|---|---|---|---|---|---|
| (Meth)acrylate | M1 | | 99.97 | 99.97 | 99.97 | 99.98 | 99.98 | 99.98 | 99.97 | 99.98 | 99.97 | 99.97 | 99.97 |
| component | 1.6HXA | | 0.03 | 0.03 | 0.03 | 0.02 | 0.02 | 0.02 | 0.03 | 0.02 | 0.03 | 0.03 | 0.03 |
| Oxetane | OXT121 | | 99.94 | 99.94 | 0.00 | 99.94 | 99.96 | 99.96 | 99.94 | 99.96 | 0.00 | 0.00 | 0.00 |
| Component | S221 | | 0.00 | 0.00 | 99.94 | 0.00 | 0.00 | 0.00 | 0.00 | 0.00 | 0.00 | 0.00 | 0.00 |
| Epoxy | YD128R | | 0.00 | 0.00 | 0.00 | 0.00 | 0.00 | 0.00 | 0.00 | 0.00 | 99.94 | 0.00 | 0.00 |
| component | HBE100 | | 0.00 | 0.00 | 0.00 | 0.00 | 0.00 | 0.00 | 0.00 | 0.00 | 0.00 | 99.94 | 0.00 |
| | DME100 | | 0.00 | 0.00 | 0.00 | 0.00 | 0.00 | 0.00 | 0.00 | 0.00 | 0.00 | 0.00 | 99.94 |
| Filler | SP3 | | 0.00 | 0.00 | 0.00 | 0.00 | 0.00 | 0.00 | 92.25 | 0.00 | 0.00 | 0.00 | 0.00 |
| component | 1055C | | 92.25 | 0.00 | 92.26 | 0.00 | 0.00 | 0.00 | 0.00 | 0.00 | 92.25 | 92.25 | 92.25 |
| | TS720 | | 0.00 | 0.00 | 0.00 | 0.00 | 0.00 | 0.00 | 0.00 | 15.38 | 0.00 | 0.00 | 0.00 |
| | LE2080 | | 0.00 | 92.25 | 0.00 | 0.00 | 0.00 | 0.00 | 0.00 | 0.00 | 0.00 | 0.00 | 0.00 |
| | F80DE | | 0.00 | 0.00 | 0.00 | 4.64 | 2.33 | 1.17 | 0.00 | 0.00 | 0.00 | 0.00 | 0.00 |
| Photoinitiator | CP101A | | 3.08 | 3.08 | 3.08 | 3.08 | 3.09 | 3.07 | 3.08 | 3.09 | 3.08 | 3.08 | 3.08 |
| component | Irg819 | | 0.41 | 0.41 | 0.41 | 0.37 | 0.39 | 0.39 | 0.41 | 0.39 | 0.41 | 0.41 | 0.41 |
| Total (parts by mass) | | | 295.68 | 295.77 | 295.69 | 208.03 | 205.76 | 204.58 | 295.68 | 218.82 | 295.68 | 295.68 | 295.68 |
| Filler | SP3 | | 0.00 | 0.00 | 0.00 | 0.00 | 0.00 | 0.00 | 15.4 | 0.00 | 0.00 | 0.00 | 0.00 |
| component | 1055C | | 33.9 | 0.00 | 33.9 | 0.00 | 0.00 | 0.00 | 0.00 | 0.00 | 33.9 | 33.9 | 33.9 |
| (% by volume) | TS720 | | 0.00 | 0.00 | 0.00 | 0.00 | 0.00 | 0.00 | 0.00 | 3.50 | 0.00 | 0.00 | 0.00 |
| | LE2080 | | 0.00 | 33.9 | 0.00 | 0.00 | 0.00 | 0.00 | 0.00 | 0.00 | 0.00 | 0.00 | 0.00 |
| | F80DE | | 0.00 | 0.00 | 0.00 | 51.9 | 35.1 | 21.3 | 0.00 | 0.00 | 0.00 | 0.00 | 0.00 |
| Peel | −30° | C. | 0.45 | 0.26 | 0.37 | 0.27 | 0.25 | 0.26 | 0.26 | 0.24 | 0.23 | 0.28 | 0.43 |
| strength | 25° | C. | 1.02 | 0.68 | 0.92 | 0.41 | 0.52 | 0.60 | 0.68 | 0.57 | 0.38 | 0.62 | 0.61 |
| (kN) | 80° | C. | 0.24 | 0.32 | 0.39 | 0.20 | 0.34 | 0.36 | 0.35 | 0.12 | 0.06 | 0.12 | 0.11 |
| Failure | −30° | C. | CF | CF | CF | CF | CF | CF | AF (AL) | AF (GL) | AF (AL) | AF (GL) | CF |
| mode | 25° | C. | CF | CF | CF | CF | CF | CF | CF | CF | AF (AL) | AF (GL) | CF |
| | 80° | C. | CF | CF | CF | CF | CF | CF | AF (AL) | AF (AL) | CF | AF (GL) | AF (GL) |

TABLE 4

| | | | EX7 | EX8 |
|---|---|---|---|---|
| (Meth)acrylate | M1 | | 0.00 | 99.97 |
| component | M2 | | 92.28 | 0.00 |
| | MAA | | 7.69 | 0.00 |
| | 1.6HXA | | 0.03 | 0.03 |
| Oxetane Component | OXT121 | | 99.94 | 99.94 |
| Filler component | 1055C | | 92.25 | 92.25 |
| Photoinitiator | CP101A | | 3.08 | 3.08 |
| component | Irg819 | | 0.41 | 0.41 |
| Total (parts by mass) | | | 295.68 | 295.68 |
| Filler component | 1055C | | 33.9 | 33.9 |
| (% by volume) | | | | |
| Peel strength (kN) | −30° | C. | 0.97 | 0.45 |
| | 25° | C. | 1.00 | 1.02 |
| | 80° | C. | 0.24 | 0.24 |
| Failure mode | −30° | C. | CF | CF |
| | 25° | C. | CF | CF |
| | 80° | C. | CF | CF |

TABLE 5

| | | | EX9 | EX10 | EX11 | EX12 | EX13 | EX14 |
|---|---|---|---|---|---|---|---|---|
| (Meth)acrylate | IBXA | | 35.54 | 43.22 | 56.62 | 56.51 | 56.50 | 56.49 |
| component | BA | | 56.75 | 56.75 | 35.00 | 35.10 | 35.12 | 35.12 |
| | MAA | | 7.68 | 0.00 | 7.61 | 0.00 | 7.63 | 7.64 |
| | AA | | 0.00 | 0.00 | 0.00 | 7.62 | 0.00 | 0.00 |
| | B76 | | 15.65 | 15.65 | 15.52 | 15.58 | 15.56 | 15.59 |
| | 1.6HXA | | 0.03 | 0.03 | 0.77 | 0.77 | 0.75 | 0.75 |
| Oxetane Component | OXT121 | | 99.69 | 99.69 | 98.95 | 99.23 | 40.02 | 99.25 |
| Filler component | 1055C | | 92.00 | 92.00 | 91.34 | 91.57 | 91.50 | 91.64 |
| | F80DE | | 1.53 | 1.53 | 1.52 | 1.52 | 1.53 | 1.53 |
| Photoinitiator | CP101A | | 3.06 | 3.06 | 1.52 | 1.52 | 1.23 | 1.53 |
| component | Irg819 | | 0.37 | 0.37 | 0.37 | 0.37 | 0.30 | 0.38 |
| Optional component | KBM403 | | 0.00 | 0.00 | 0.00 | 0.00 | 0.00 | 3.07 |
| (Silane coupling | | | | | | | | |
| agent) | | | | | | | | |
| Total (parts by mass) | | | 312.30 | 312.30 | 309.21 | 309.79 | 252.13 | 312.99 |
| Filler component | 1055C | | 26.3 | 26.3 | 26.4 | 26.4 | 31.1 | 26.2 |
| (% by volume) | F80DE | | 18.3 | 18.3 | 18.9 | 18.9 | 22.5 | 18.9 |
| Total filler component (% by | | | 44.6 | 44.6 | 45.3 | 45.3 | 53.6 | 45.0 |
| volume) | | | | | | | | |
| Peel strength (kN) | −30° | C. | 0.90 | 0.47 | 0.46 | 0.57 | 0.22 | 0.36 |
| | 25° | C. | 1.09 | 1.02 | 1.56 | 1.73 | 0.36 | 1.00 |
| | 80° | C. | 0.36 | 0.33 | 0.39 | 0.37 | 0.20 | 0.25 |
| Failure mode | −30° | C. | CF | CF | CF | CF | CF | CF |
| | 25° | C. | CF | CF | CF | CF | CF | CF |
| | 80° | C. | CF | CF | CF | CF | CF | CF |

TABLE 6

| | | | EX15 | EX16 | EX17 | EX18 |
|---|---|---|---|---|---|---|
| (Meth)acrylate | IBXA | | 56.50 | 56.06 | 56.05 | 55.19 |
| component | BA | | 35.11 | 34.85 | 34.87 | 34.32 |
| | MAA | | 7.63 | 7.58 | 7.59 | 0.00 |
| | AA | | 0.00 | 0.00 | 0.00 | 7.51 |
| | B76 | | 15.58 | 15.45 | 15.47 | 15.22 |
| | 1.6HXA | | 0.76 | 1.52 | 1.49 | 2.97 |
| Oxetane Component | OXT121 | | 142.51 | 174.29 | 213.00 | 171.62 |
| Filler component | 1055C | | 91.64 | 90.90 | 90.92 | 87.60 |
| | F80DE | | 1.53 | 1.90 | 1.53 | 1.87 |
| Photoinitiator | CP101A | | 1.75 | 1.74 | 1.92 | 1.72 |
| component | Irg819 | | 0.39 | 0.39 | 0.38 | 0.38 |
| Optional component (Silane | KBM403 | | 3.07 | 3.02 | 3.03 | 2.97 |
| coupling agent) | | | | | | |
| Total (parts by mass) | | | 356.47 | 387.69 | 426.26 | 381.39 |
| Filler component | 1055C | | 23.6 | 21.1 | 20.2 | 20.7 |
| (% by volume) | F80DE | | 17.0 | 18.9 | 14.6 | 18.9 |
| Total filler component (% by volume) | | | 40.6 | 40.0 | 34.8 | 39.5 |
| Peel strength (kN) | −30° | C. | 0.49 | 0.63 | 0.78 | 1.56 |
| | 25° | C. | 1.88 | 1.70 | 1.34 | 1.79 |
| | 80° | C. | 0.36 | 0.32 | 0.21 | 0.62 |
| Failure mode | −30° | C. | CF | CF | CF | CF |
| | 25° | C. | CF | CF | CF | CF |
| | 80° | C. | CF | CF | CF | CF |

It will be apparent to those skilled in the art that various modifications can be made to the embodiments and examples described above without departing from the basic principles of the present invention. It will also be apparent to those skilled in the art that various improvements and modifications of the present invention can be made without departing from the gist and scope of the present invention.

### REFERENCE SIGNS LIST

100 Jig

101 Tempered glass

103 Mirror button

1. A curable adhesive comprising a (meth)acrylate polymer, a curable oxetane compound, a polymer filler, and a photoinitiator for curable oxetane compounds.

2. The adhesive according to claim 1, wherein a content of the curable oxetane compound is from 30 to 300 parts by mass per 100 parts by mass of the (meth)acrylate polymer.

3. The adhesive according to claim 1, wherein a content of the polymer filler is from 10 to 80% by volume.

4. The adhesive according to claim 1, wherein the (meth)acrylate polymer is a polymer obtained from a material comprising a (meth)acrylate monomer and a carboxylic acid.

5. The adhesive according to claim 4, wherein a content of the carboxylic acid is from 3 to 20% by mass per 100% by mass of a total amount of the (meth)acrylate monomer and the carboxylic acid.

6. The adhesive according to claim 4, wherein the (meth)acrylate monomer further comprises an alkyl (meth)acrylate monomer having a homopolymer glass transition temperature of 0° C. or lower and an alkyl (meth)acrylate monomer having a homopolymer glass transition temperature of 50° C. or higher.

7. The adhesive according to claim 1, further comprising a forming aid polymer.

8. An adhesive tape comprising a layer comprising the adhesive according to claim 1 and a release liner.

9. A laminate comprising a substrate and a layer comprising the adhesive according to claim 1.

10. A laminated mirror button comprising a mirror button and a layer comprising the adhesive according to claim 1.
